(19) United States
(12) Patent Application Publication
(10) Pub. No.: US 2020/0389450 A1
(43) Pub. Date: Dec. 10, 2020

(54) SYSTEMS AND METHODS FOR HOLISTIC DIGITIZED CONSUMER IDENTITY AND DATA

(71) Applicant: JPMORGAN CHASE BANK, N.A., New York, NY (US)

(72) Inventors: Whittney Anne LEVITT, New York, NY (US); Howard SPECTOR, Woolwich, NJ (US); Tuan DAO, Richardson, TX (US)

(21) Appl. No.: 16/891,718

(22) Filed: Jun. 3, 2020

Related U.S. Application Data
(60) Provisional application No. 62/857,851, filed on Jun. 6, 2019.

(51) Int. Cl. H04L 29/06; G06Q 20/36; G06Q 20/40; G06Q 20/38; G06Q 20/10; G06Q 40/02; G06Q 30/00

(52) U.S. Cl. CPC H04L 63/0853; H04L 63/102; G06Q 20/3674; G06Q 20/363; G06Q 30/0185; G06Q 20/385; G06Q 20/102; G06Q 40/02; G06Q 20/4014

(57) ABSTRACT

In one embodiment, in an information processing apparatus comprising at least one computer processor, a method for issuing an identity verification token to a user may include: (1) receiving, from a user, identity information; (2) generating an identity profile for the user comprising the identity information; (3) associating an identity verification token with at least some of the identity information in the identity profile; and (4) communicating the identity verification token to the user. The user may store the identity verification token in an electronic wallet.

### RELATED APPLICATIONS

This application claims priority to, and the benefit of, U.S. Patent Application Ser. No. 62/857,851 filed Jun. 5, 2019, the disclosure of which is hereby incorporated by reference it its entirety.

### BACKGROUND OF THE INVENTION

### 1. Field of the Invention

Exemplary embodiments are generally directed to systems and methods for holistic digitized consumer identity and data.

### 2. Description of the Related Art

It is difficult for customers to open new accounts with different institutions and entities (e.g., banks and merchants). When customers do open these new accounts between different institutions and entities, they often lose all of the data from previous accounts they had so they have to start from scratch and recreate such information as all past data, account preferences, and personalization. Thus, customers cannot leverage their data across different accounts. This prevents customers from making informed decisions and also results in them missing out on possible benefits.

It is also difficult for customers to complete such account openings between different institutions and entities as the capabilities are limited or nonexistent for customers to view, use, understand, and control their data, across different institutions.

These and other deficiencies exist. Exemplary embodiments solve these deficiencies.

### SUMMARY OF THE INVENTION

Systems and methods for holistic digitized consumer identity and data are disclosed.

An exemplary embodiment includes a system and method for creating a federated identity for a customer. The federated identity may include customer, customer account, and other data. The customer data may be created by an identity provider at the request of the customer or a bank or other entity. The customer may control the permissions on and access to his/her data. The customer identity data may be encrypted.

Another exemplary embodiment includes a system and method of using customer data to open an account. Upon receiving an account opening request, a bank or other entity may request data on the customer. As part of the account opening request, the customer may provide an identity verification token to the bank or other entity. The identity verification token may be a unique value that may be transferred among institutions as a key to retrieve customer data. The request may be sent to an identity provider that may maintain customer identity data for the customer. The request may originate through an interface in an application or computer program. The identity of the requester may be verified. Upon successful verification, the identity provider may provide the requested data. The customer may be notified of the request and the customer may provider approval to provide his/her data to the requester. The access may be in the form of a key or other method to access the customer identification data.

Another exemplary embodiment includes a system and method of using the identity verification token to complete a transaction, such as customer onboarding. The identity verification token may reference account information associated a particular customer. The account information may be related to one or more payment accounts associated with the customer. The identity verification token may be stored in a wallet. When a third party receives a transaction request in which the payment information in the wallet is presented, a request may be sent to an identity provider who, upon successful verification of identity verification token, may provide authorization to proceed with the transaction and any necessary information for the third party to complete the transaction.

In one embodiment, in an information processing apparatus comprising at least one computer processor, a method for issuing an identity verification token to a user may include: (1) receiving, from a user, identity information; (2) generating an identity profile for the user comprising the identity information; (3) associating an identity verification token with at least some of the identity information in the identity profile; and (4) communicating the identity verification token to the user. The user may store the identity verification token in an electronic wallet.

In one embodiment, the information processing apparatus may be associated with a trusted party.

In one embodiment, the identity information may include the user's name, the user's address, the user's phone number, at least one user transaction account, at least one user asset, at least one user transaction, combinations therefore, etc.

In one embodiment, the method may further include receiving, from the user, at least one sharing permission for sharing the identity verification token with a third party.

In one embodiment, the identity verification token may have an expiration.

In one embodiment, the identity verification token may be a single-use token.

In one embodiment, the method may further include associating a second identity verification token with at least some of the identity information in the identity profile, at least some of the identity information associated with the second identity verification token being different from the identity information associated with the identity verification token.

In one embodiment, the method may further include receiving an update to at least some of the identity information from the user; updating the identity profile with the update; and associating the identity verification token with the updated identity profile.

According to another embodiment, in an information processing apparatus comprising at least one computer processor, a method for account opening using an identity verification token may include: (1) receiving, from a third party, an identity verification token and a request to verify an identity of a user, wherein the user provided the identity verification token to the third party; (2) retrieving a stored permission for the user for using the verification token; (3) determining that the third party is a permissioned to receive user identity verification; (4) verifying that the identity verification token received from the third party matches a stored identity verification token associated with the user; and (5) confirming the user identity verification to the third party.

In one embodiment, the method may further include authenticating the third party.

In one embodiment, the request further may include a request for account information, and the method may further include: determining that the third party is a permissioned to receive the user account information; and providing the user account information to the third party after the user's identity is verified.

In one embodiment, a link to the user account information may be provided.

In one embodiment, the user account information may include online bill pay for the user, recurring payment information for the user, know your customer information, etc.

According to another embodiment, in an information processing apparatus comprising at least one computer processor, a method for conducting a transaction using an identification verification token may include: (1) receiving, from a third party that is conducting a transaction with a user, an identity verification token and a request for user contact information, wherein the user provided the identity verification token to the third party; (2) retrieving a stored permission for the user for using the verification token; (3) determining that the third party is a permissioned to receive user contact information; (4) verifying that the identity verification token received from the third party matches a stored identity verification token associated with the user; and (5) providing the user contact information to the third party, wherein the third party conduct the transaction using the user contact information.

In one embodiment, the method may further include authenticating the third party.

In one embodiment, the method may further include executing a fraud check on the user information request.

In one embodiment, the user contact information may include a user shipping address.

These and other embodiments and advantages will become apparent from the following detailed description, taken in conjunction with the accompanying drawings, illustrating by way of example the principles of the various exemplary embodiments.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for holistic digitized consumer identity and data according to one embodiment.

FIG. 2 depicts a method for issuing an identity verification token in accordance with an exemplary embodiment.

FIG. 3 depicts a system and method for opening a new account using an identification verification token in accordance with an exemplary embodiment.

FIG. 4 depicts a system and method for conducting a transaction using an identification verification token in accordance with an exemplary embodiment.

FIG. 5 depicts a system and method for processing a lifecycle identification information event in accordance with an exemplary embodiment.

### DETAILED DESCRIPTION OF THE PREFERRED EMBODIMENTS

Exemplary embodiments relate to providing customer data, federated identity and associated data across entities, channels and use cases. Exemplary embodiments provide a federated identity that may include aggregated data relating to a customer that is controlled at the customer level and may be used in support of a variety of transactional situations, such as opening accounts, linking accounts, verifying or retrieving personal information, and conducting transactions with merchants, banks, and other parties.

An identity verification token may be associated with customer identity data. In one embodiment, the identity verification token may be used to provide identity verification as-a-service, where a customer may provide his or her identity verification token to third party, and the third party may verify the customer's identity by providing the customer's identity verification token to the identity provider, which may be the issuer of the identity verification token. The identity provider may verify the customer using the identity verification token and may return a valid/invalid identity verification to the third party.

As used herein, the term “bank” may include institutions that provide financial services to their members or customers. Banks may include, but are not limited to financial institutions, banks, credit unions, trust companies, mortgage loan companies, financial technology (FinTech) providers, insurance companies, investment banks, underwriters, and brokerage firms.

As used herein the term “customer” may refer to an individual who holds at least one account with a financial institution. For example, the customer may have one or more credit accounts and/or a checking account with a financial institution. In various embodiments, “customer” may also be referred to as a “user.”

There is a need for banks and other institutions to verify a customer's identity. Because of this, banks and other institutions need verifiable data of the customer's identity. For example, banks have requirements to “know your customer” (KYC), and must comply with regulations from the Office of Foreign Assets Control (OFAC) and Anti-Money Laundering rules (AML). Once a customer's identity is validated, the need to separately check the identity for separate transactions is eliminated. Having the customer create an identity profile with a trusted provider ensures that the customer's identity can be easily verified as required, and the customer receives the added benefit of having a federated profile that may be used for a variety of different transactions and situations where the customer's identity is needed.

Exemplary embodiments provide a model and an ownership layer of customer data, federated identity and associated data across entities, channels, and use cases. The customer data may be aggregated, and controlled at the customer level versus at a specific bank/entity relationship or even one level down at specific account/payment method level. This customer data may be agnostic of a bank or any other entity.

The customer may have complete control over his or her identity data, allowing the customer to control what identity data is shared, and with whom the identity data is shared. The control may be complete in that the customer may determine what data is may be accessed by an identity verification token by third parties. Examples include initiating transfers of agreed upon data, funds, rights, and authentication across third parties, banks, data users, payment rails, loyalty programs, social media accounts, applications, financial technology provides, merchants, as well as other users of the customer's identity and account information. The identity verification token may be used for authentication and replace existing authentication data and techniques.

The identity verification token may also be associated with one or more of payment details, transaction info, account numbers, underlying asset values/ownership, loyalty and rewards programs, preferences/personalization, identity (e.g., for opening accounts, approvals, cross entity sharing, credit bureaus, authentication data, payment preferences, know your customer information, etc.

An identity provider, such as a trusted entity that is trusted by all parties in network, may verify the identity verification token. An example of such a third party is a bank. The identity provider may provide identity verification as a service to other parties, such as a merchant, a bank, etc. and may provide access some or all underlying identity verification data for the customer. In various embodiments, if a request for identity verification and/or the underlying data is made by a party other than the customer, the identity provider may seek approval from the customer to validate the access request.

In one embodiment, the identity provider may issue the identity verification token to the customer, and the customer may provide the identity verification to other parties as required.

According to exemplary embodiments, the identity verification token may be accepted and used by all key entities for a variety of use cases (e.g., transactions, opening accounts, etc.). Examples of entities that may accept and use the identity verification token include bankers, credit bureaus, merchants, employers, payment rails, financial technology applications, etc. The identity verification token may be in a format that permits it to be passed across banks, merchants, other institutions, and other providers. The customer may control the entities that receive and access the identity verification token. The customer may further control what underlying identity data may be accessed by each entity.

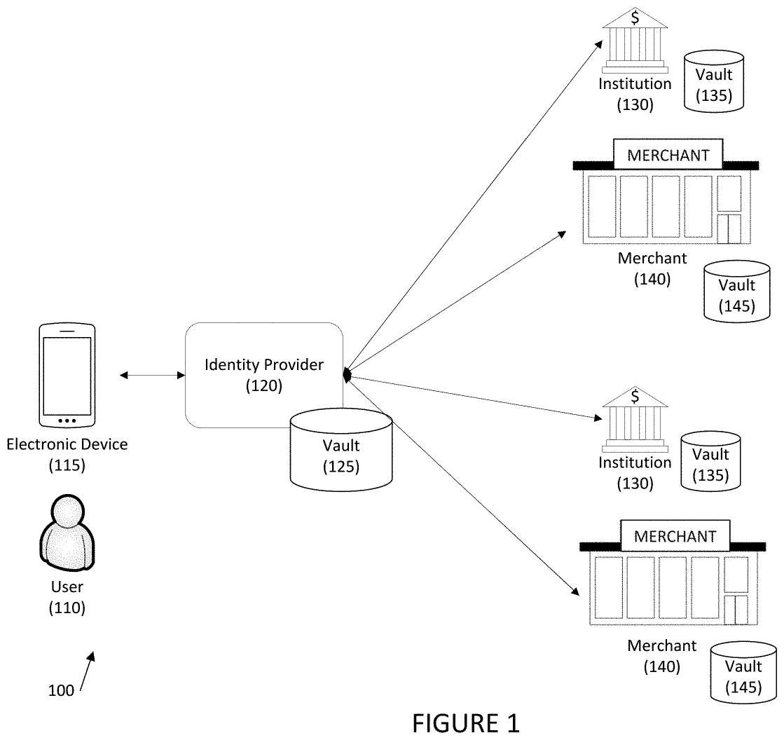

Referring to FIG. 1, a system for holistic digitized consumer identity and data is provided according to one embodiment. System 100 may include user 110 that may use electronic device 115 to interface with identity provider 120. Electronic device 115 may be any suitable electronic device, such as smart phones, computers, Internet of Things appliances, vehicles, etc. Any suitable electronic device may be used as is necessary and/or desired.

Identity provider 120 may be a third party, a trusted party, etc. that may provide identity services for a plurality of users, including user 110. In one embodiment, identity provider 120 may be a financial institution, a financial technology (“FinTech”) service provider, etc.

Identity provider 120 may maintain vault 125 of identity verification tokens for a plurality of customers, including user 110. The identity verification tokens may be mapped to certain parts of an identity profile for each customer.

System 100 may further include one or more institution 130 and/or merchant 140, and each may maintain its own vault 135, 145, respectively. Although two institutions 130 and two merchants 140 are depicted in FIG. 1, it should be recognized that a greater or fewer number of each may be provided as is necessary and/or desired.

In one embodiment, one or more of identity provider 120, institution 130, and merchant 140 may participate as nodes in a distributed ledger network, such as a blockchain network. This may facilitate the validation and tracking of updates across vaults 125, 135, and/or 145. Each node may maintain a full or partial copy of the distributed ledger, and, in one embodiment, each node may have access only to user data associated with its users, or the users that have granted access to the user data. In one embodiment, the user data may be encrypted and may only be accessed with the appropriate key.

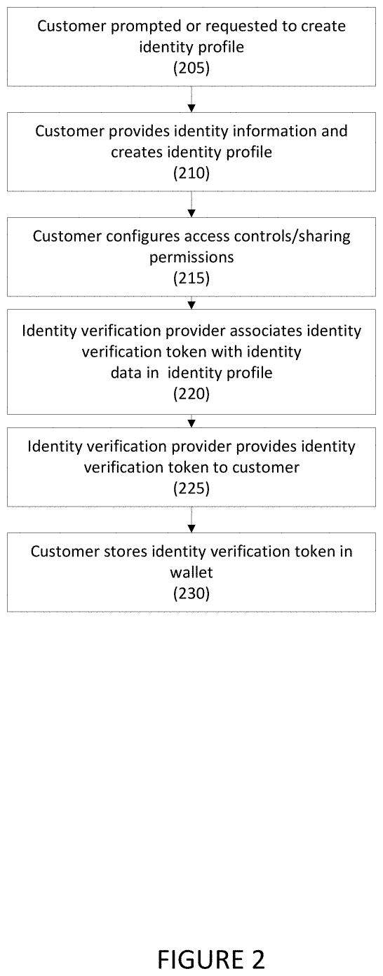

Referring to FIG. 2, a method for issuing an identity verification token is provided according to one embodiment.

In step 205, the user may be prompted or requested to create an identity profile. The request may be part of a promotion from a bank or the identity provider, or as part of opening a new account or financial instrument with a bank. In embodiments, the bank may provide the customer with one or more incentives to create the identity profile, such as the receipt of loyalty rewards, access to a particular financial instrument, a better interest rate on a transaction with the bank, etc.

In one embodiment, the identity provider may be a third party, a trusted party, etc. For example, the identity provider may be a bank or financial institution.

In step 210, the customer may provide identity information to the identity provider. For example, the customer may confirm or provide a range of information about the customer, such as the customer's name, contact information, accounts (e.g., including payment card account information, such as credit card account information), loyalty and reward account information, payment details, transaction info, underlying asset values/ownership, preferences/personalizations, identity verification, etc. The customer identity data may be encrypted and stored in secure storage.

In one embodiment, the identity provider may generate a customer identity profile including the identity information.

In one embodiment, the customer may be authenticated by any suitable manner.

In step 215, the customer may configure access controls and sharing permissions on his/her identity information. The access controls and sharing permissions may include, for example, who is authorized to access the customer identity data, as well as what data are accessible and for what period of time to those authorized entities. In various embodiments, the customer may request and require notification when an entity requests access to the customer's data. The customer may be required to provide approval to allow the access to proceed

In step 220, the identity provider may create or assign an identity verification token with some or all of the identity data in the customer profile. For example, identity verification token may be a unique identifier that is mapped to some or all of the identity data. More than one identity verification token may be generated, and each identity verification token may be associated with a different amount of identity data.

In one embodiment, the identity verification token may be a single-use token, a limited-use token, or it may not have any use limitations. The identity verification token may be limited to certain geographies, merchants, times of day, etc. In one embodiment, the identity verification token may expire after a certain amount of time.

In step 225, the identity provider may provide the identity verification token to the customer, and, in step 230, the customer may store the identity verification token in his or her wallet.

In one embodiment, the customer may access his/her information at any time and may modify the access controls and sharing permissions on the identity data using the unique identifier. In various embodiments, the customer may provide authorization for specific access requests and may approve the specific data shared as part of those access requests. This may allow for certain access requests to proceed without approval of the customer since the customer has pre-approved those requests.

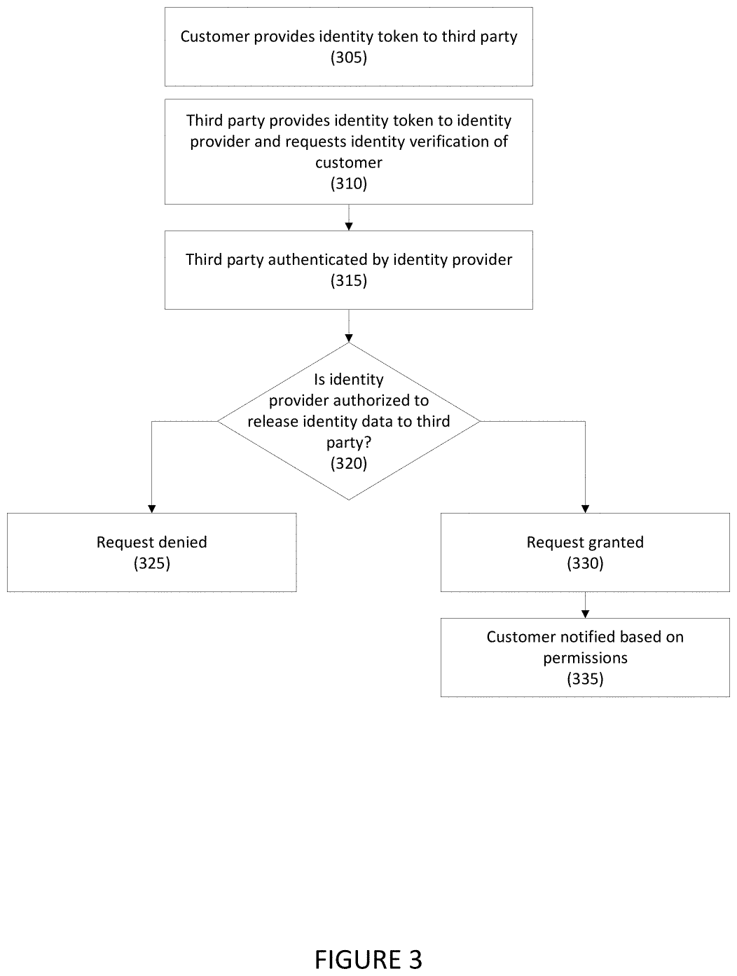

Referring to FIG. 3, a method for opening an account using an identification verification token is disclosed according to one embodiment. For example, a third party (e.g., a merchant, bank, etc.) may have a need to access the customer's identity data. The need for access may be part of a request from the customer to open a new account, or to link an identity of the customer across accounts with different institutions and/or merchants (e.g., associate a loyalty account with a merchant to a credit card account with a financial institution). As another example, a third party may request access to the customer's data, such as to verify an account or payment information. The access request requirement may arise in response to action taken by the customer.

In one embodiment, the customer may be transferring the account to a new bank, and may use the identification verification token to verify the customer's identity and for the new bank to retrieve certain identification information, account information (e.g., online billpay payees, recurring payments, etc.) as is necessary and/or desired.

In step 305, instead of, or in addition to, providing identifying information, the customer may provide an identity verification token to a third party. The customer may provide the identity verification token from the customer's electronic wallet.

In step 310, the third party may provide the identity verification token to the identity provider and request that the identity provider verify the customer's identity. For example, the third party may access and launch an authentication user interface through an application or program on a computer or other electronic device. This interface may provide access to the identity provider.

In one embodiment, the third party may request certain identification data in the customer's profile, such as KYC information.

In step 315, the third party may be authenticated with the identity provider. In one embodiment, the third party may first validate the identity of the third party using, for example, a OAUTH token or a similar mechanism.

In step 320, the identity provider may verify that the customer has authorized release of identity verification and/or the release of the requested customer identity data to the third party. If the request falls outside the scope of authorized disclosures, in step 320, the request may be denied.

If the request is within the scope of authorized disclosures, and the customer's identity is verified, in step 330, the identity provider may confirm verification of the customer's identity. In one embodiment, the identity provider may provide the third party with access to the requested customer identification data. In one embodiment, the requested customer identification data may be sent in the clear, may be encrypted, etc. In another embodiment, the identity provider may provide the third party with a link to the data and a key to decrypt the requested identification data.

In step 335, based on permissions set by the customer, the customer may be notified of the access request and may need to approve the access request to his/her data before access is provided to the third party.

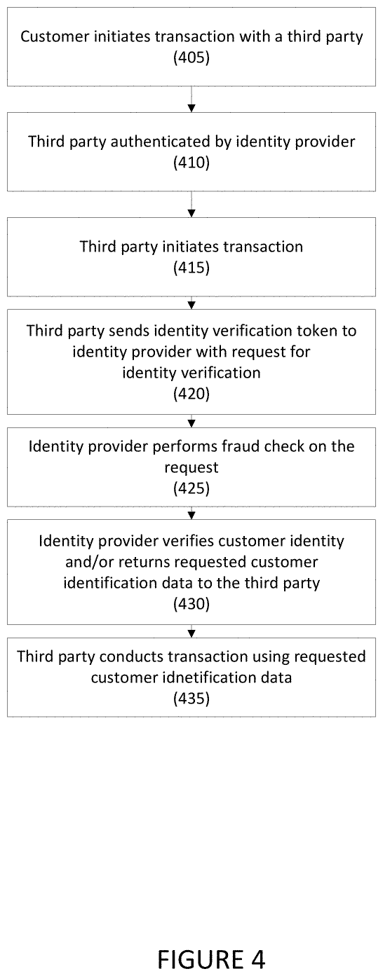

Referring to FIG. 4, a method for conducting a transaction using an identification verification token is provided according to one embodiment.

In step 405, the customer may initiate a transaction with a third party, such as a merchant or a bank. As part of the transaction, the customer may provide its identity verification token to the third party.

In one embodiment, other than providing the unique identifier, the customer may remain anonymous to the third party.

In step 410, the third party may be authenticated by the identity provider. For example, the third party may provide an OAUTH access token or other security mechanism to validate the third party's identity before the third party may use the unique identifier to access the identity data.

In step 415, the third party may initiate the transaction by, for example, running the transaction, applying loyalty rewards, etc.

In step 420, the third party may then send the identity verification token from the user to the identity provider with a request for customer identity verification and/or customer identity information.

In step 425, the identity provider may perform a fraud check on the request, and, if the customer's identity is verified, in step 430, may provide the third party with the requested customer identification data, or a key to decrypt the customer identification data. For example, the identity provider may provide the third party with the customer's shipping address.

In step 435, the third party may conduct the transaction using the customer identification data.

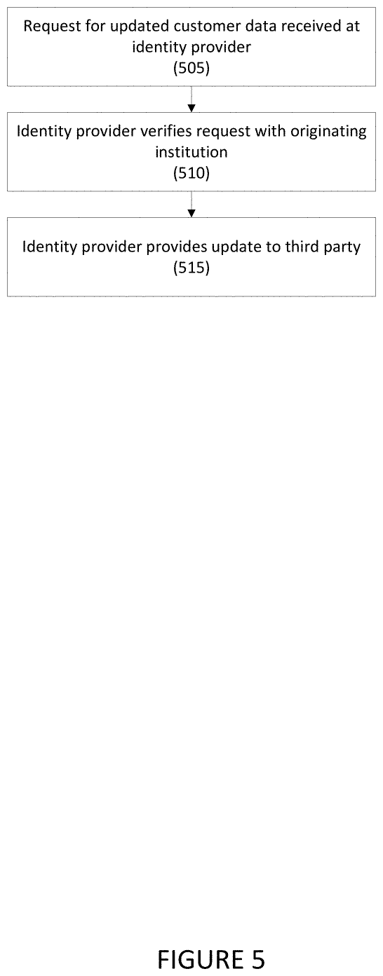

FIG. 5 depicts an illustrative example of processing a lifecycle event according to exemplary embodiments.

In step 505, a third party, such as a merchant, bank, FinTech, or wallet provider, may request an update to customer identification data from the identity provider. Examples of change may include an account change (e.g., account number change, name change, address change, etc.), account status change (e.g., closed, suspended, fraud detected, etc.), account profile change, etc. For example, a customer may move, and may request that the customer identification data be changed.

In step 510, the identity provider may verify the request. In one embodiment, the institution with which the lifecycle event originated may verify the request. For example, customer may be presented with the updated address information and may verify its accuracy.

In step 515, the identity provider may provide the update to the customer identification data to the third party, customer, etc. In one embodiment, the identity provider may validate the update with the third party, customer, etc. by validating the signature for the data matches the data that was sent. In one embodiment, if a distributed ledger is employed, the update may be written to the distributed ledger, and the vaults may automatically update their records.

The disclosure of U.S. Provisional Patent Application Ser. No. 62/994,189, filed Mar. 24, 2020, is hereby incorporated, by reference, in its entirety.

It will be readily understood by those persons skilled in the art that the various embodiments are susceptible to broad utility and application. Many embodiments and adaptations other than those herein described, as well as many variations, modifications and equivalent arrangements, will be apparent from or reasonably suggested by the various embodiments and foregoing description thereof, without departing from the substance or scope of the various embodiments.

Accordingly, while the various embodiments have been described here in detail in relation to its exemplary embodiments, it is to be understood that this disclosure is only illustrative and exemplary of the various embodiments and is made to provide an enabling disclosure of the various embodiments. Accordingly, the foregoing disclosure is not intended to be construed or to limit the various embodiments or otherwise to exclude any other such embodiments, adaptations, variations, modifications or equivalent arrangements.

Various exemplary methods are provided by way of example herein. These methods are exemplary as there are a variety of ways to carry out methods according to the present disclosure. The methods depicted and described can be executed or otherwise performed by one or a combination of various systems and modules. Each block shown in the methods represents one or more processes, decisions, methods or subroutines carried out in the exemplary method, and these processes, decisions, methods or subroutines are not necessarily carried out in the specific order outlined in the methods, nor is each of them required.

Further, the various embodiments and their advantages may be understood by referring to the accompanying figures. It should be appreciated that the various examples in the attached figures are exemplary and non-limiting.

What is claimed is:

1. A method for issuing an identity verification token to a user, comprising:
in an information processing apparatus comprising at least one computer processor:
receiving, from a user, identity information;
generating an identity profile for the user comprising the identity information;
associating an identity verification token with at least some of the identity information in the identity profile; and
communicating the identity verification token to the user;
wherein the user stores the identity verification token in an electronic wallet.

2. The method of claim 1, wherein the information processing apparatus is associated with a trusted party.

3. The method of claim 1, wherein the identity information comprises at least one of the user's name, the user's address, the user's phone number, at least one user transaction account, at least one user asset, and at least one user transaction.

4. The method of claim, 1, further comprising:
receiving, from the user, at least one sharing permission for sharing the identity verification token with a third party.

5. The method of claim 1, wherein the identity verification token has an expiration.

6. The method of claim 1, wherein the identity verification token is a single-use token.

7. The method of claim 1, further comprising:
associating a second identity verification token with at least some of the identity information in the identity profile, at least some of the identity information associated with the second identity verification token being different from the identity information associated with the identity verification token.

8. The method of claim 1, further comprising:
receiving an update to at least some of the identity information from the user;
updating the identity profile with the update; and
associating the identity verification token with the updated identity profile.

9. A method for account opening using an identity verification token, comprising:
in an information processing apparatus comprising at least one computer processor:
receiving, from a third party, an identity verification token and a request to verify an identity of a user, wherein the user provided the identity verification token to the third party;
retrieving a stored permission for the user for using the verification token;
determining that the third party is a permissioned to receive user identity verification;
verifying that the identity verification token received from the third party matches a stored identity verification token associated with the user; and
confirming the user identity verification to the third party.

10. The method of claim 9, further comprising:
authenticating the third party.

11. The method of claim 9, wherein the request further comprises a request for account information, and further comprising:
determining that the third party is a permissioned to receive the user account information; and
providing the user account information to the third party after the user's identity is verified.

12. The method of claim 11, wherein a link to the user account information is provided.

13. The method of claim 11, wherein the user account information comprises online bill pay for the user.

14. The method of claim 11, wherein the user account information comprises recurring payment information for the user.

15. The method of claim 11, wherein the user account information comprises know your customer information.

16. A method for conducting a transaction using an identification verification token, comprising:
in an information processing apparatus comprising at least one computer processor:
receiving, from a third party that is conducting a transaction with a user, an identity verification token and a request for user contact information, wherein the user provided the identity verification token to the third party;
retrieving a stored permission for the user for using the verification token;
determining that the third party is a permissioned to receive user contact information;
verifying that the identity verification token received from the third party matches a stored identity verification token associated with the user; and
providing the user contact information to the third party, wherein the third party conduct the transaction using the user contact information.

17. The method of claim 16, further comprising:
authenticating the third party.

18. The method of claim 16, further comprising:
executing a fraud check on the user information request.

19. The method of claim 16, wherein the user contact information comprises a user shipping address.
